(19) United States
(12) Patent Application Publication
(10) Pub. No.: US 2007/0157516 A1
(43) Pub. Date: Jul. 12, 2007

(54) Staged modular hydrocarbon reformer with internal temperature management

(76) Inventor: Bernhard A. Fischer, Rochester, NY (US)

Correspondence Address: DELPHI TECHNOLOGIES, INC., M/C 480-410-202, PO BOX 5052, TROY, MI, 48007, US

(21) Appl. No.: 11/327,870

(22) Filed: Jan. 9, 2006

(51) Int. Cl. H01M 8/06

(52) U.S. Cl. 48/61

(57) ABSTRACT

A hydrocarbon reformer comprising a plurality of sequential reforming stages separated by non-reforming spaces. The first stage catalyst bed is an egg-crate structure divided into fully active, partially active, and inactive flow cells arranged such that fully active cells are adjacent only to partially active and inactive cells. Fuel and air flowing through the partially active and inactive cells cool the catalyst bed, thereby preventing thermal excess in the first stage and consequent bed erosion. Fuel and oxygen thus heated in the first stage are mixed at the end of the first stage with the reformate formed, and the mixture is provided to the next stage, which is fully catalytic, to yield a final reformate. Because the fuel and oxygen in the second stage are diluted with reformate from the first stage, insufficient heat is generated in the fully-catalytic second stage to cause thermal degradation thereof.

The present invention relates to hydrocarbon reformers for producing fuel for fuel cells; more particularly, to such a reformer comprising a plurality of sequential reforming stages; and most particularly, to a staged reformer system wherein reforming is controlled and limited in a first stage to prevent thermal degradation of the reformer.

### BACKGROUND OF THE INVENTION

Partial catalytic oxidizing (CPOX) reformers are well known in the art as devices for converting hydrocarbons to reformate containing hydrogen (H₂) and carbon monoxide (CO) as fuel for fuel cell systems, and especially for solid oxide fuel cell (SOFC) systems.

Prior art CPOx reformers typically comprise a catalyst bed formed of a durable inert substrate coated with an active catalytic wash coat. The substrate is typically porous, presenting a large surface area for catalysis.

A serious problem for prior art catalyst beds is that intense exothermic catalysis occurs at the leading edge of the bed where the concentration of reactants is highest and the dispersal of heat is lowest, causing rapid exothermic heat release and buildup which results in unacceptably elevated substrate, washcoat, and catalyst temperatures.

During sustained use of the reformer, the catalyst bed is progressively eroded thermally along the leading edge, resulting in a progressively smaller bed and eventual failure of the reformer.

What is needed in the art is a hydrocarbon reformer wherein temperature of the catalyst bed is controlled inherently by the arrangement of the bed, whereby thermal degradation of the catalyst bed is prevented.

It is a principal object of the present invention to prevent failure of a hydrocarbon reformer by thermal degradation of the leading edge of the catalyst bed.

### SUMMARY OF THE INVENTION

Briefly described, a hydrocarbon reformer in accordance with the invention comprises a plurality of sequential reforming stages, preferably two, separated by non-reforming mixing spaces. The first reforming stage is arranged such that only a predetermined portion of the substrate surface available to hydrocarbon fuel and air in the first stage is provided with catalyst. The first stage catalyst bed is an egg-crate structure divided into fully active, partially active, and inactive flow cells. The cells are arranged such that fully active cells are adjacent to partially active and inactive cells, allowing fuel and air flowing through the partially active and inactive cells to cool the catalyst bed, thereby preventing thermal excess in the first stage and consequent bed erosion. Fuel and oxygen thus heated in the first stage are mixed at the end of the first stage with the reformate formed, and the mixture is provided to the next stage, which is preferably fully catalytic. Because the fuel and oxygen in the second stage are diluted with reformate from the first stage, insufficient heat is generated in the second stage to cause thermal degradation thereof.

### BRIEF DESCRIPTION OF THE DRAWINGS

The present invention will now be described, by way of example, with reference to the accompanying drawings, in which:

FIG. 1 is a schematic elevational longitudinal cross-sectional view of a prior art CPOx reformer;

FIG. 2 is a schematic elevational longitudinal cross-sectional view of a multiple-stage CPOx reformer improved in accordance with the invention;

FIG. 3 is an isometric view of a modular slotted catalytic plate in accordance with the invention;

FIG. 4 is an isometric view of two plates like the plate shown in FIG. 3 being joined to form a partial rectangular plate structure;

FIG. 5 is an isometric view of a completed plate structure (“egg-crate”) suitable for forming a stage in the improved reformer shown in FIG. 2;

FIG. 6 is an isometric view of the plate structure shown in FIG. 5 installed in a frame;

FIG. 7 is a plan view of an exemplary first assembly arrangement of a catalyst bed in accordance with the invention; and

FIG. 8 is a plan view of an exemplary second assembly arrangement of a catalyst bed in accordance with the invention.

### DESCRIPTION OF THE PREFERRED EMBODIMENTS

The distinctions and benefits of the present invention may be better appreciated by first considering the elements and limitations of a prior art catalytic reformer.

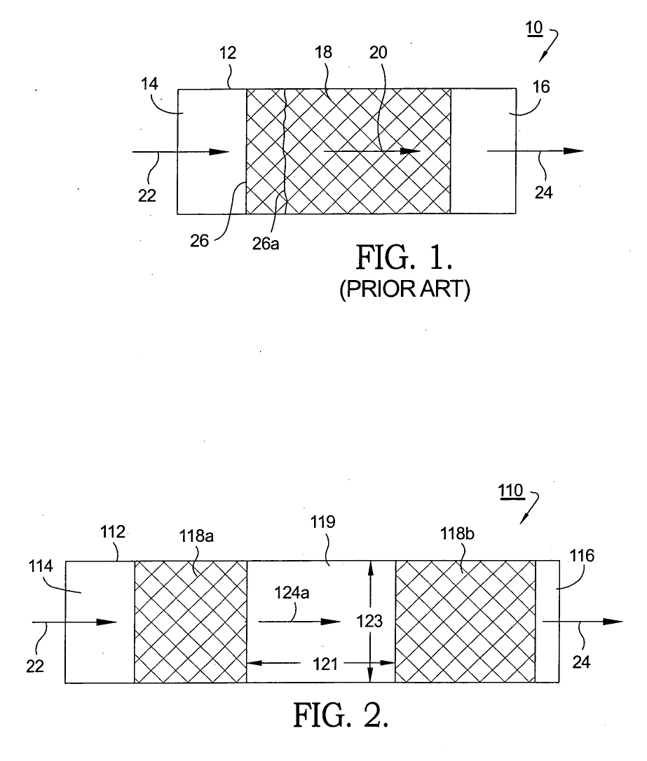

Referring to FIG. 1, a prior art hydrocarbon catalytic reformer 10 includes a housing 12 having an inlet 14 and outlet 16. Disposed within housing 12 is a catalyst bed 18 having porosity in at least a longitudinal direction 20. Bed 18 typically includes a durable non-catalytic substrate coated with a washcoat including or supporting catalytic means. Conventional means for controlling overall temperature, fuel flow rate, air flow rate, and the like are assumed but not shown in FIG. 1.

In operation, a mixture 22 of hydrocarbon and oxygen, typically in the form of air, is introduced into reformer 10 through inlet 14, and is passed through catalyst bed 18 wherein the hydrocarbon fuel and air are converted to a reformate 24 comprising a mixture of molecular hydrogen and carbon monoxide.

As noted above, a shortcoming of a prior art reformer such as reformer 10 is that the leading edge 26 of catalyst bed 18 becomes overheated and suffers thermal erosion over time of use, resulting in a recession of bed edge 26 to a new bed edge 26a which continues to recede with continued use of the reformer.

Referring to FIG. 2, an improved hydrocarbon reformer 110 in accordance with the invention also comprises a housing 112 having an inlet 114 and outlet 116. A catalyst bed 118 is divided into a plurality of bed stages, preferably two stages 118a, 118b, separated by an intermediate chamber 119 having a length 121 preferably about 1.5 times the width 123 of bed stages 118.

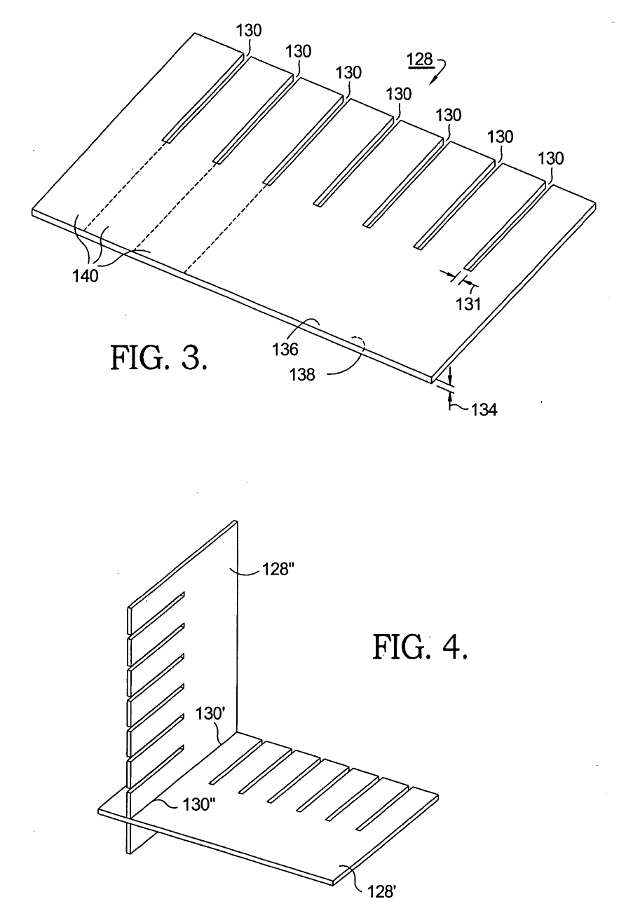

In operation, a mixture 22 of hydrocarbon and oxygen, typically in the form of air, is introduced into reformer 110 through inlet 114, and is passed through first catalyst bed 118a wherein a first portion of the hydrocarbon fuel and air are converted to molecular hydrogen and carbon monoxide, resulting in an intermediate mixture 124a of hydrogen, carbon monoxide, fuel, and air in intermediate chamber 119. Mixture 124a is homogenized by turbulence and passed through second catalyst bed 118b which is fully catalytic wherein the remaining fuel is reformed, yielding reformate 24. Referring now to FIGS. 2 through 8, a structure 126 will now be described for first catalyst bed 118a which provides for inherent internal temperature control within first catalyst bed 118a and prevents thermal erosion of the leading edge thereof as in the prior art. Referring to FIG. 3, a slotted plate 128 is provided with a plurality of slots 130, preferably equally spaced apart, each slot extending half way across plate 128. The width 131 of each slot is equal to the thickness 134 of plate 128. Plate 128 is a catalyst substrate element which may be coated with catalyst composition on one side 136, both sides 136, 138, or selectively in exemplary patterns 140 on either side.

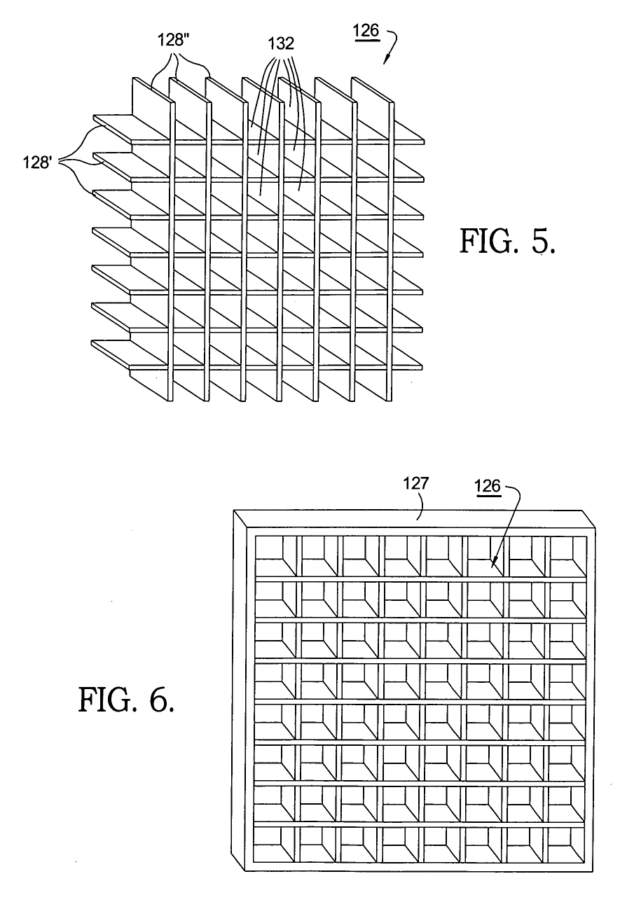

Referring to FIG. 4, two slotted plates 128′, 128″ may be joined by interlocking respective slots 130′, 130″ thereof; and, referring to FIG. 5, “egg-crate” structure 126 may be formed by joining of a plurality of slotted plates 128′ and slotted plates 128″ in similar fashion, resulting in a plurality of cells 132 arranged in a rectangular array.

It is obvious that when both sides 136, 138 of all plates 128′, 128″ are coated with catalyst composition prior to assembly of the plates into structure 126, all four walls of each flow cell 132 are catalytically active. In such an arrangement, catalysis proceeds in each cell, and no mechanism or path exists to remove the exothermic heat of catalysis other than the materials passing through the cells and being catalyzed. As has been recited for prior art catalyst beds, the result is that the bed will overheat and become thermally eroded.

What is needed is a means to remove some of the heat being generated, which can be achieved by rendering some of the flow cells non-catalytic or only partially catalytic. Fortunately, this is readily accomplished in accordance with the invention as follows.

Each plate 128 is not fully coated to a catalyst composition on each side, thus lo reducing the active catalytic area of each plate. Preferably, each plate 128 is fully coated on only side 136 or 138, which automatically reduces by one-half the total catalytic area of structure 126. If plates thus coated are assembled in random side-to-side orientation to form structure 126, the resulting flow cells will be a mixture of zero-, one-, two-, three-, and four-sided catalytically coated cells. Cells having little or no catalytic capability provide little or no reforming and thus contribute little or no heat to the overall heating. Rather, fuel/air mixture flowing through such cells abstracts heat from the structure being generated in those cells having greater reforming capability.

Thus, in first stage 118a, temperature is inherently controlled by decreased catalysis and increased flow of cooling medium.

Referring to FIG. 6, structure 126 is preferably captured in a metal frame 127. The plates may be brazed to each other at their joining surfaces or may remain loosely connected but brazed into the frame.

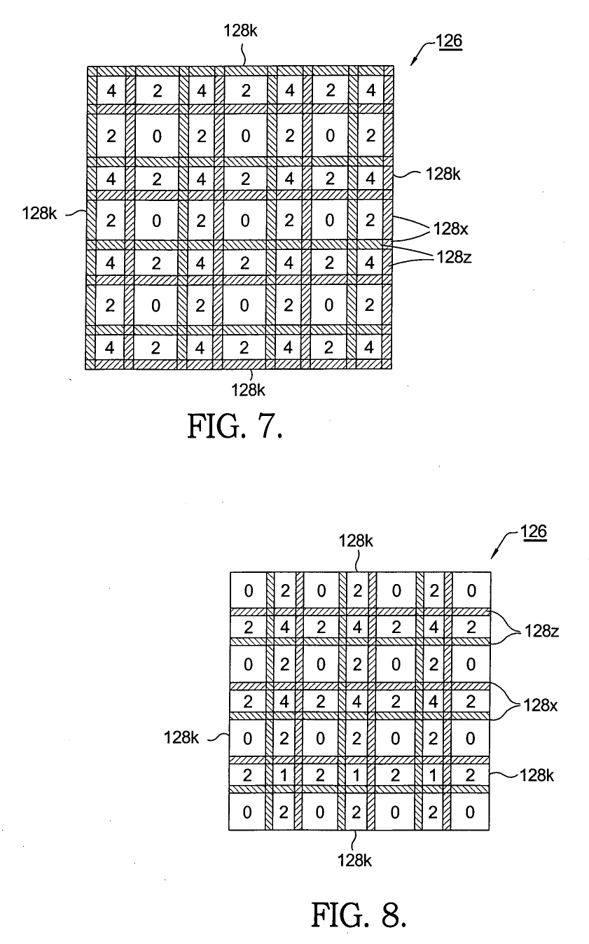

Referring to FIGS. 7 and 8, in a currently preferred construction arrangement of structure 126, the orientations of plates 128′ and of plates 128″ are alternated through the structure such that like sides of adjacent parallel plates face each other, giving rise to flow cells having 0, 2, or 4 walls comprising catalytic coating, the numbers of catalytic walls being indicated in the respective cells. (In FIGS. 7 and 8, the plate substrate 128x is indicated by a solid line and the catalytic coating 128z is indicated by cross-hatching.)

Note that the catalytic capacity of the structure shown in FIG. 7 is significantly greater than is the catalytic capacity of the structure shown in FIG. 8, although each structure has 7×7=49 flow cells. This because the surround plates 128k in FIG. 7 are fully catalytic, and surround plates 128m in FIG. 8 and non-catalytic. Note further that if the surround plates in FIG. 8 were made fully catalytic, the corner 0 cells would become 2 cells, and the edge 2 cells would become 3 cells.

Note also that the fully catalytic 4 cells are non-contiguous, being separated by half-catalytic 2 cells on all four sides and by non-catalytic 0 cells on all four diagonals.

Other selective coatings and orientations of plates 128 as may become obvious to those of skill in the art are fully comprehended by the invention. The invention thus provides a nearly infinite number of arrangements available to tailor the competing catalytic and cooling characteristics of an egg-crate catalyst bed to provide maximum catalytic capacity without risk of overheating the leading edge of the structure and resultant thermal erosion thereof.

The number of plates 128′, 128″, and the corresponding number of flow cells 132, can vary depending upon application needs from as little as a few dozen to thousands. Each flow cell and the whole grid structure can be designed for low pressure loss which enhances overall reformer system efficiency. For example, as many as 100 plates might be used in each direction to provide upwards of 10,000 flow cells in a single module.

The invention provides a modular approach toward reformer power requirements.

Rather than increasing the number of plates and cells to form a very large single catalyst bed, smaller structures 126 may be joined together in parallel in a large frame to form a single large bed as may be desired.

Referring again to FIGS. 2 and 6, a structure 126 is also useful for second catalyst bed 118b. Obviously, all plates 128 should be coated on both sides to provide full catalysis in all flow cells, as residual hydrocarbon in reformate 24 is both undesirable and wasteful.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A hydrocarbon reformer for reforming hydrocarbon fuel and oxygen into a reformate, comprising:
a) a housing having an inlet for conveying a flow stream of hydrocarbon fuel and oxygen into said reformer and an outlet for conveying a flow stream of said reformate out of said housing;
b) a first catalyst bed disposed in said housing; and
c) a second catalyst bed disposed in said housing downstream of said first catalyst bed in a flow direction of said streams through said housing.

2. A reformer in accordance with claim 1 wherein said second catalyst bed is spaced apart from said first catalyst bed.

3. A reformer in accordance with claim 2 wherein a portion of the surface of said first catalyst bed is free of catalytic material.

4. A reformer in accordance with claim 3 wherein the surface of said second catalyst bed is fully coated with catalytic material.

5. A reformer in accordance with claim 1 wherein at least one of said first and second catalyst bed includes an egg-crate structure.

6. A reformer in accordance with claim 5 wherein said egg-crate structure comprises:
a) a first plurality of first spaced-apart parallel plates extending in a first direction; and
b) a second plurality of second spaced-apart parallel plates extending in a second direction substantially orthogonal to said first direction,
wherein catalytic material is deposited on less than all of the surfaces of said first and second plates.

7. A reformer in accordance with claim 6 wherein at least one of said first plates have a first plurality of spaced-apart first slots extending partially across said plate in a widthwise direction; and
b) at least one of said second plates have a second plurality of spaced-apart second slots extending partially across said plate in a widthwise direction,
wherein said first spaced-apart slots and second spaced-apart slots are interlocked to form said structure.

8. A reformer in accordance with claim 6 wherein said catalytic material is deposited on an entire first side of each of said first and second plates, and wherein said second side of each of said first and second plates is free of said catalytic material.

9. A reformer in accordance with claim 7 wherein said first plates are arranged in said structure such that like sides of said first plates are facing each other, and wherein said second plates are arranged in said structure such that like sides of said second plates are facing each other.

10. A reformer in accordance with claim 6 wherein said catalytic material is deposited on portions of said first and second plates and wherein said first and second plates are arranged in said structure such that a plurality of flow cells is formed in said structure, each of said flow cells having four walls.

11. A reformer in accordance with claim 10, wherein the number of catalytic walls of said four walls is selected from the group consisting of zero, one, two, three, and four.

12. A reformer in accordance with claim 1 wherein said second catalyst bed is an egg-crate structure.

13. A reformer substrate having an egg-crate structure, said structure comprising a first plurality of first spaced-apart parallel plates extending in a first direction and a second plurality of second spaced-apart parallel plates extending in a second direction substantially orthogonal to said first direction, wherein catalytic material is deposited on less than all of the surfaces of said first and second plates.
